(19) United States
(12) Patent Application Publication
(10) Pub. No.: US 2008/0067192 A1
(43) Pub. Date: Mar. 20, 2008

(54) VISCOUS MATERIAL FEED SYSTEM AND METHOD

(76) Inventors: Jennifer L. Stanton, Clifton, NY (US); Hal Bayly, Mechanicville, NY (US); Roger Knox, Clifton Park, NY (US)

Correspondence Address: PHILIP D FREEDMAN PC;PHILIP D FREEDMAN, 317 S. FAYETTE STREET, ALEXANDRIA, VA, 22314-5902, US

(21) Appl. No.: 11/532,334

(22) Filed: Sep. 15, 2006

(51) Int. Cl. B67D 5/08

(52) U.S. Cl. 222/56

(57) ABSTRACT

A viscous material feed system comprises a container evacuator located on a loss of weight scale; a feed tube that receives material expressed from a container by the container evacuator; and a dicing apparatus that meters material from the feed tube to a processing system according to loss of weight sensed by the scale. A viscous material feed method comprises determining an initial weight of a combined feed system, container and viscous material held within the container; evacuating viscous material from the container by the feed system for charge to a viscous material compounding process; monitoring a weight of the combined feed system, container and viscous material held within the container as material is evacuated; determining an amount of viscous material charged to the compounding process according to a difference between the initial weight and a monitored weight of the combined feed system, container and viscous material held within the container as material is evacuated; controlling a rate of dicing viscous material that is evacuated from the container for feed to the viscous material compounding process according to the determined amount of charged viscous material.

### BACKGROUND OF THE INVENTION

The invention relates to a viscous material system and method and metering assembly and method, in particular for supplying an organopolysiloxane gum or other viscous material from successively loaded drums to a continuous compounding system.

In a compounding system, a material is fed to a processing line where feed is mixed and additives are injected in proportions to produce a customized product. This system requires precise and reliable dosing and feed operations to achieve uniform products with narrow tolerance properties. Accurately metering the material in a feed step can be critical to proper system operation.

However, it is difficult to separate an accurate quantity of a viscous material from a bulk of the material. Accurate separation is difficult because of slow response of the viscous material to a change in feed rate and because of the difficulty in separating a metered aliquot of the viscous material from a bulk of the material. The material may be resistant to pouring or if it can be poured, pour rate is extremely slow. A viscous material may exhibit high levels of adhesion or tendency to stick to other materials and/or cohesion or a tendency to remain stuck to itself and therefore not separable. The viscous material may be shear thickening, exhibiting increasing viscosity as shear on the fluid is increased and therefore becoming increasingly resistant to flow as shear is increased. It is difficult to feed accurate quantities of such materials so that an amount in a process can be controlled.

Accordingly, there is a need in the art to facilitate separating difficult-handling viscous material. Also, there is a need to accurately cut defined quantities of such material from a bulk quantity, regardless of the form of the bulk quantity, and there is a need to be able to charge the viscous material to a processing system.

### BRIEF DESCRIPTION OF THE INVENTION

The invention provides an improved system and method to cut and meter difficult-handling material to a processing system. In a first embodiment, the invention is a viscous material feed system, comprising: a container evacuator located on a loss of weight scale; a feed tube that receives material expressed from a container by the container evacuator; and a dicing apparatus that meters material from the feed tube to a processing system according to loss of weight sensed by the scale.

In another embodiment, the invention is a viscous material feed method, comprising: determining an initial weight of a combined feed system, container and viscous material held within the container; evacuating viscous material from the container by the feed system for charge to a viscous material compounding process; monitoring a weight of the combined feed system, container and viscous material held within the container as material is evacuated; determining an amount of viscous material charged to the compounding process according to a difference between the initial weight and a monitored weight of the combined feed system, container and viscous material held within the container as material is evacuated; controlling a rate of dicing viscous material that is evacuated from the container for feed to the viscous material compounding process according to the determined amount of charged viscous material.

In another embodiment, the invention is a silicone gum feed system, comprising: a drum press located on a loss of weight scale; a feed tube that receives material expressed from a drum by the drum press; a dicing apparatus that meters material from the feed tube to a processing system according to loss of weight sensed by the scale; and a controller with a set of instructions to store an initial weight, monitor a continuing weight, determine weight of silicone gum fed to the processing system according to a difference between the initial weight and the monitored weight and controlling a rate of the dicing apparatus according to the difference.

In another embodiment, the invention is a method of controlling a feed to a processing system, comprising: establishing a material feed session set point range; feeding a viscous material in the session by dicing a steadily moving material into a portion that drops sequentially into the processing system; monitoring a session total of material dropped into the processing system; comparing the session total of material to the session set point range; increasing a dicing rate of the moving material to decrease each diced portion quantity as the session set point range is approached; and terminating the material feed of the session when the total material is within the session set point range.

In another embodiment, the invention is a material feed system, comprising: a material extracting apparatus; and a controller with a set of instructions: to (i) refer to a look-up data base to determine a set point for a material to be charged to a compounding system; (ii) sense an initial combined weight of a material extracting apparatus and a container with material; (iii) signal commencement of operation of the material extracting apparatus to evacuate material from the container; (iv) sense a progressing combined weight of the material extracting apparatus and the container with material; (v) calculate a charged material weight according to a difference between the initial combined weight and the sensed progressing combined weight; and (vi) terminating the material extracting apparatus operation when a calculated charged material weight is within a predetermined range of the set point.

In still another embodiment, the invention is a process to feed a material compounding system, comprising: referring to a look-up data base to determine a set point for a material to be charged to the compounding system; sensing an initial combined weight of a material extracting apparatus and a container with material; signaling commencement of a material extracting apparatus operation to evacuate the material from the container; sensing a progressing combined weight of the material extracting apparatus and the container with material; calculating a charged material weight according to a difference between the initial combined weight and the sensed progressing combined weight; and terminating the material extracting apparatus operation when a calculated charged material weight is within a specified range of the set point.

In still another embodiment, the invention is a controller for a feed to a processing system, comprising a set of instructions to establish a material feed session set point range; to direct feeding a viscous material in the session by dicing a steadily moving material into a portion that drops sequentially into the processing system; to monitor a session total of material dropped into the processing system; to compare the session total of material to the session set point range; to increase a dicing rate of the moving material to decrease each diced portion quantity as the session set point range is approached; and to terminate the material feed of the session when the total material is within the session set point range.

In another embodiment, the invention is a viscous material processing system, comprising: a container evacuator; a controller that drives the container evacuator; a feed tube that receives material expressed from a container by the container evacuator according to the controller; and a dicing apparatus that severs material from the feed tube to meter the material to a processor according to the controller.

In another embodiment, the invention is a method of feed a processing system, comprising: setting a total batch viscous material feed to a compounding system; initiating a feed of the viscous material at a first set feed rate by dicing feed material at a first sized aliquot; monitoring the feed rate and total batch viscous material feed; changing the first sized aliquot to a second small sized aliquot as the total viscous material feed approaches a set point to provide an improved control of quantity of the batch viscous material feed.

In still another embodiment, the invention is a method of controlling feed to a processing system, comprising: sensing a first weight of a combined viscous feed system, container and viscous material within the container; expressing a diced portion viscous material from the container and viscous feed system to a processing system; sensing a subsequent weight of the combined viscous feed system, container and viscous material within the container; and determining a quantity of viscous material fed to the processing system by a difference between the first weight and the subsequent weight; controlling an expressed diced portion of viscous material according to the quantity of viscous material fed to the processing system.

In still another embodiment, the invention is a silicone gum processing system, comprising: a silicone gum compounding system; and a viscous material feed system to the compounding system, the feed system comprising a dicing apparatus that meters material according to weight of material charged to the compounding system as monitored by a controller.

In another embodiment, the invention is a method of processing silicone gum, comprising: monitoring weight of material charged to a silicone gum compounding system; controlling the metering of material to the compounding system by a dicing apparatus according to the monitored weight of charged material; and compounding charged silicone gum in the compounding system.

### BRIEF DESCRIPTION OF THE DRAWING

FIG. 1, FIG. 2 and FIG. 3 are schematic representations of a material processing system;

FIG. 4 and FIG. 5 are perspective views of a drum press; and

FIG. 6 is a cut away view of a section of a drum press.

### DETAILED DESCRIPTION OF THE INVENTION

The invention relates to the handling of a viscous material such as a silicone gum. A silicone or polysiloxane or organopolysiloxane has the chemical formula [R₂SiO]ₙ, where R=organic groups such as methyl, ethyl, and phenyl. These materials typically comprise an inorganic silicon-oxygen backbone ( . . . —Si—O—Si—O—Si—O— . . . ) with attached organic side groups, which can be four-coordinate. In some cases organic side groups can be used to link two or more of these —Si—O— backbones together.

By varying the —Si—O— chain lengths, side groups, and crosslinking, silicones can be synthesized with a wide variety of properties and compositions. They can vary in consistency from liquid to gel to rubber to hard plastic. Silicone rubber or silicone gum is a silicone elastomer, typically having high temperature properties. Silicone rubber offers resistance to extreme temperatures, being able to operate normally from minus 100° C. to plus 500° C. In such conditions tensile strength, elongation, tear strength and compression set can be superior to conventional rubbers.

A silicone gum can be extruded or molded into custom shapes and designs such as tubes, strips, solid cord or custom profiles within size restrictions specified by a manufacturer. Cord can be joined to make “0” Rings and extruded profiles can also be joined to make up seals.

It is desirable to provide a viscous feed metering system that accurately and efficiently processes viscous materials such as silicone gum for use in various applications. However, these materials can be highly resistant to flow, highly adhering, highly cohering, and/or shear thickening and consequently very difficult to handle. Accuracy of a packaging process and/or accuracy of a process of obtaining a defined quantity of such material, for example in a continuous process is costly when substantial time is required for cutting or separating of a quantity of the material from a larger quantity. Also, it is costly and wasteful to have to clean the processing equipment on a frequent basis when the fluid material sticks to a cutting tool or instrument; also, it is costly, and disadvantageous when an incorrect amount of material is used in a downstream process which uses the material.

A viscous feed metering system can require emptying material such as silicone gum from barrels or similar containers. Many of these processing systems produce highly customized products to particular applications. Producing a customized product requires precise adjustment of product proportions, requiring precise feed of materials. However, precise feed of a viscous material is difficult. The material must somehow be diced into measurably aliquots that can be controlled to provide a target feed quantity.

Sometimes a cutting tool, such as a knife, blade or scissors is used to dice portions of a viscous material from a bulk or other quantity supply. For example, a feed portion of viscous material can be cut from a large bulk mass, from a pulled relatively thin cross-sectional string or from a generally cylindrical-shape of the viscous material. One disadvantage of trying to move a blade or the like through a viscous material is the relatively large amount of force that may be required and the time and machinery required to apply such force. Another disadvantage to moving a blade or the like through the fluid material is the adherence of the material to the blade, especially if the fluid material is sticky (highly adhering). The cutting tool may require frequent cleaning to remove accumulation of the fluid material that has stuck thereto. Such accumulation of fluid material on the cutting tool may be particularly rapid where the fluid is cohesive, being highly self adhering. Also, as the material sticks to the cutting tool, the force and work required to move the cutting tool through the material further increases.

The invention provides a system and method to dice and feed difficult to handle viscous materials. Features of the invention will become apparent from the drawings and following detailed discussion, which by way of example without limitation describe preferred embodiments of the invention.

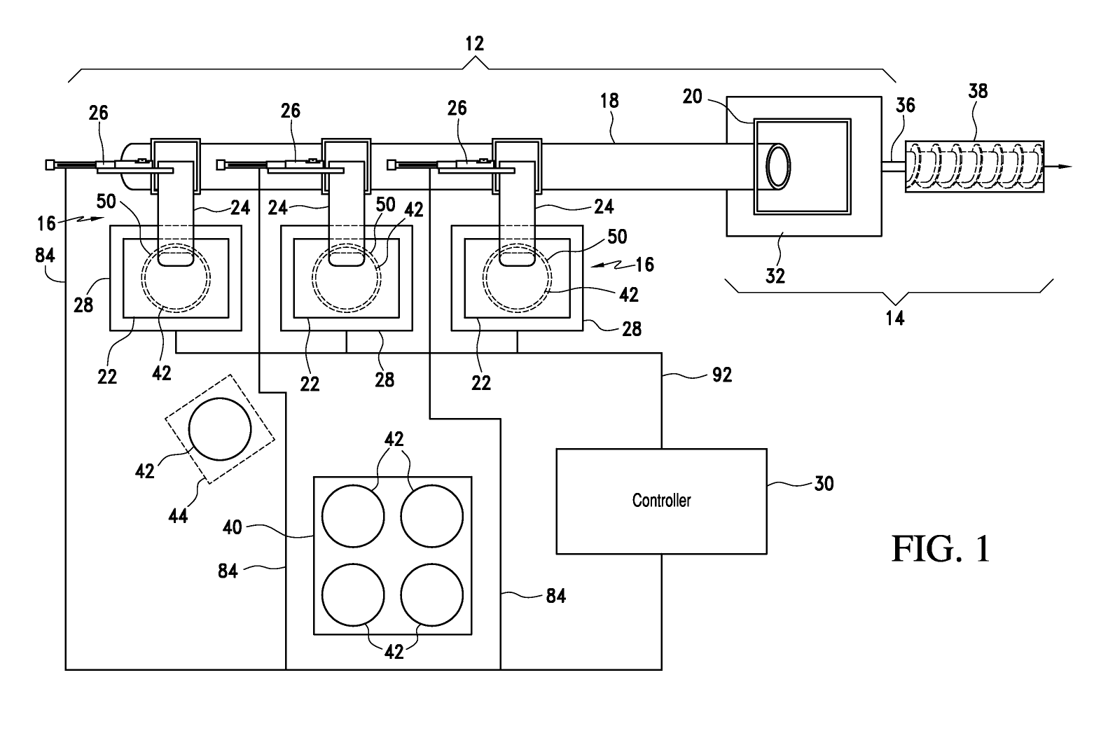

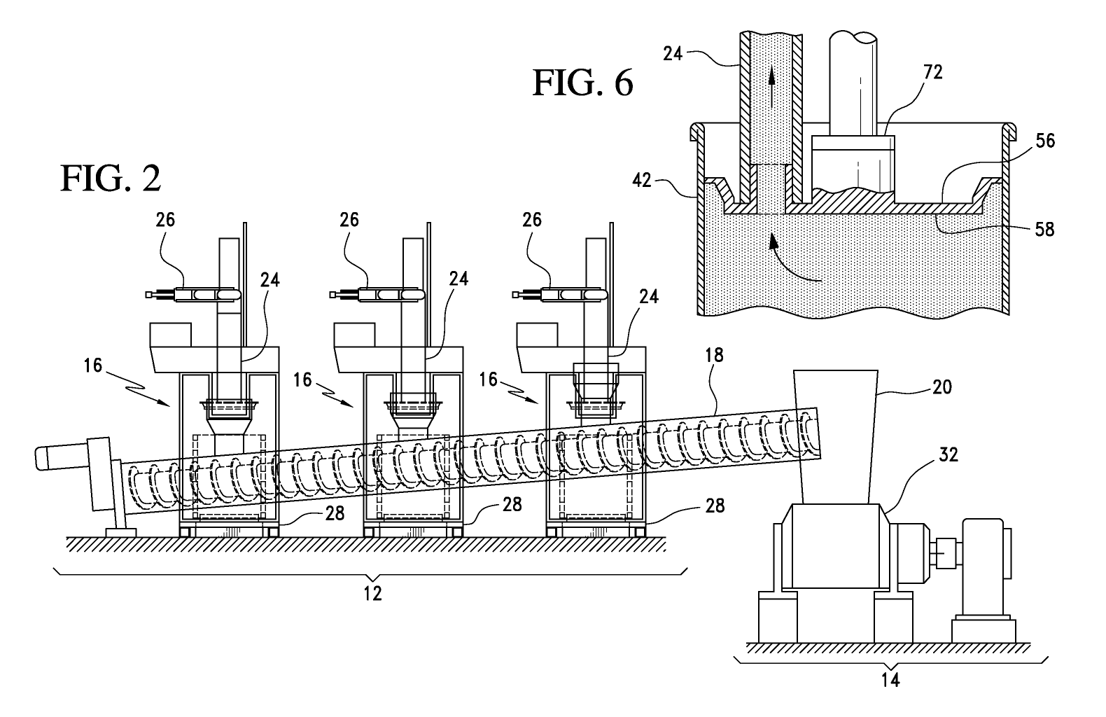

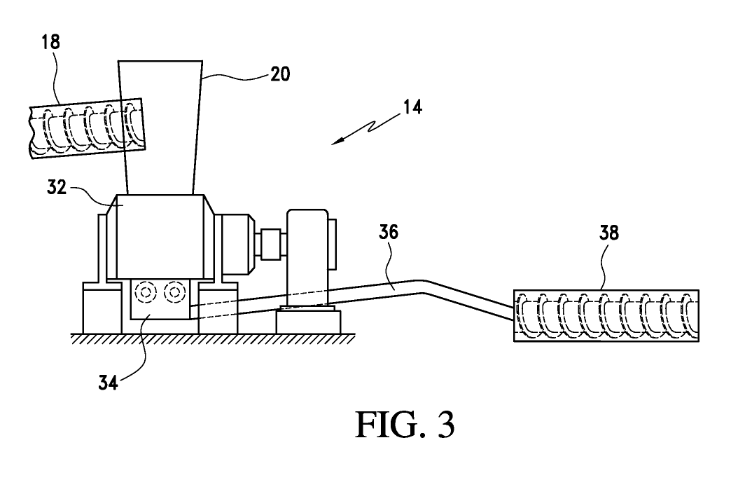

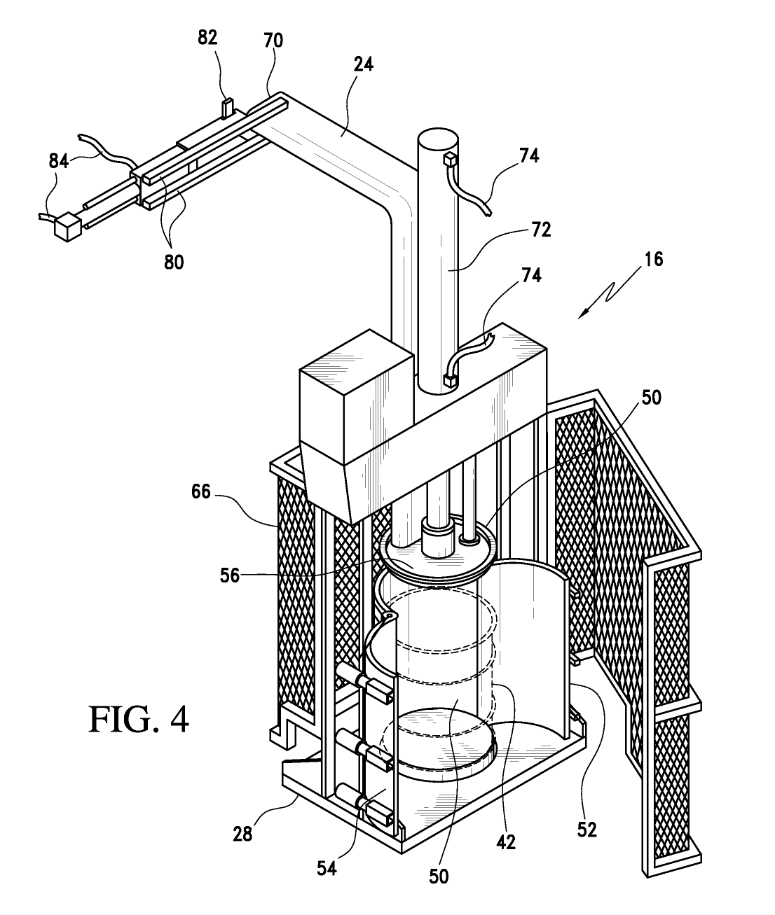

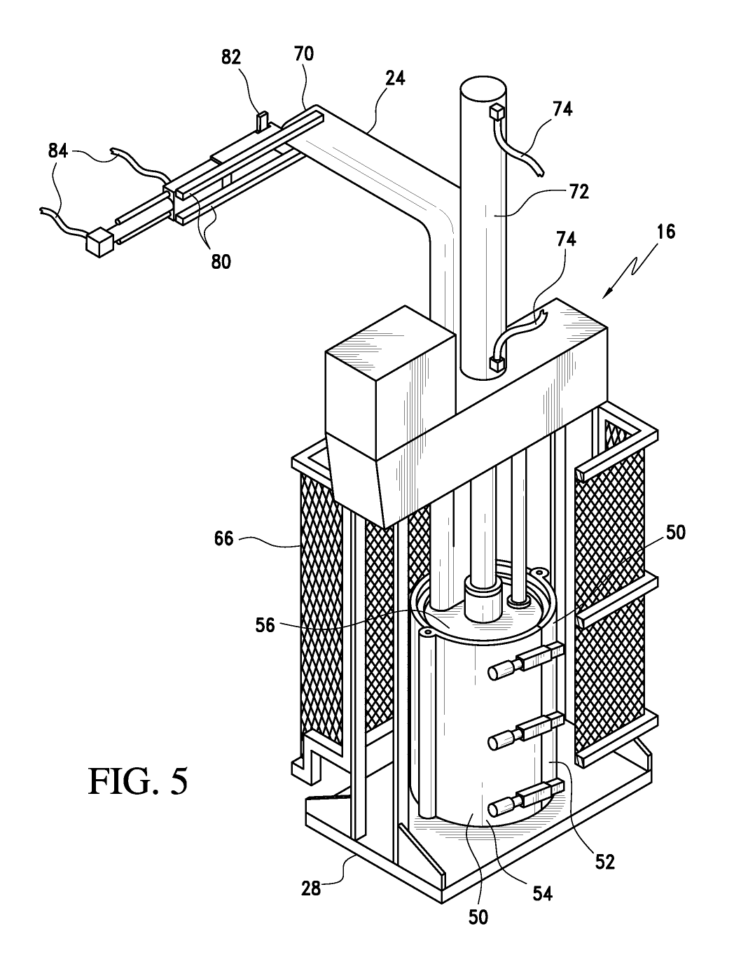

The invention relates to a material feed system and method for evacuating material from a container for feed to a processing system. A preferred invention embodiment shown in the drawings illustrates the invention as a process to compound silicone rubber (silicone gum) into a base for forming articles. In the drawings, FIG. 1 is a schematic top view representation and FIG. 2 is a schematic side view representation of a material processing system 10 showing an integrated feed system 12 and compounding system 14. The feed system 12 includes a material extractor apparatus (MEA) 16, conveyor 18 and chute 20. FIG. 4 and FIG. 5 are detailed elevation views of the MEA 16 and FIG. 6 is a cut away side sectional view of a section of the MEA 16. The MEA 16 includes container evacuator 22, feed tube 24, dicing apparatus 26 and floor scale 28. The integrated feed system 14 is controllably connected to controller 30. FIG. 6 is a schematic side view of compounding system 14. As shown in FIG. 1, FIG. 2 and FIG. 3, compounding system 14 includes mixer 32, roll mill 34, conveyor belt 36 and compounder 38.

The MEA 16 serves to express the viscous material from a container to the compounding system 14. In typical prior art operations, 55-gallon steel drums from a pallet are dumped into totes and the totes (approx. 80 pounds each) are dumped into a Banbury mixer. However, manually maneuvering drums from pallets can cause back and shoulder strains and injuries. In a preferred compounding operation of the invention with respect to FIG. 1, FIG. 2 and FIG. 3, operation commences with delivery of a pallet 40 of four drums 42 of gum. While the container can be any material holding enclosure, the drawings embodiment is a feed system including a method of evacuating a silicone gum-containing drum. A suitable drum 42 in the embodiment has full openable ends and has a cylindrical wall of steel, fiberboard or other material suitable for transporting a silicone gum material. The drum 42 has opposite ends, each of which is openable to accommodate a movable plunger at one end as hereinafter described.

The material in the drums 42 may be identical or it may be of a variety of physical properties such as viscosity. The drums 42 are removed from the pallet 40 one by one by drum hauler 44 such as from Easy Lift Equipment Co., Inc., 2 Mill Park Court, Newark, Del. 19713. The lid of each of three drums 42 is removed and each of the drums 42 is loaded by the hauler 44 into a respective container evacuator 42, which may be a Schwerdtel S 6-F drum press. Use of the drum hauler 44 eliminates ergonomic risks associated with lifting and handling the heavy drums 42. The silicone gum is then forced from each drum in measured aliquots by the MEA 16 into the conveyor 18. In the drawings embodiment, the MEA 16 comprises a container evacuator 22, feed tube 24 and dicing apparatus 26. The container evacuator 22 can be a drum press, which is a device that evacuates viscous or compacted contents from a drum. As illustrated in FIG. 2 and FIG. 3, the container evacuator 22 is a press that comprises a substantially cylindrical chamber 50 with hinged closures 52 and 54 for securing a drum 42 removably within the chamber 50. The chamber 50 and hinged closures 52 and 54 securely cradle the drum 42 during a material extracting operation. A disc-shaped platen 56 fits into the chamber 50 with a flat driving surface 58 oriented perpendiculars to the longitudinal axis of the chamber 50 and correspondingly perpendicular to the longitudinal axis of a drum 42 held within the chamber 50.

The operation of feed system 12 can be described with reference to FIG. 1, FIG. 2, FIG. 4, FIG. 5 and FIG. 6. In operation, the press closures 52 and 54 are manually unlatched by activating clamps and opening closures 52 and 54. The drum hauler 44 is used to load a first drum 42 into the press cavity 60. The drum 42 is secured by a locator ring 62 at the base 64 of the chamber 50. The right closure 52 is first closed then the left closure 54 by engaging a door switch by an actuator (not shown). The cage chamber 66 is closed and the actuator secures the press closures 52 and 54 at the commencement of a batch system cycle. The press closures 52 and 54 take pressure of the hydraulic system from a drum 42 that may be thin-walled.

Each MEA 16 includes the container evacuator 22, feed tube 24 and dicing apparatus 26 and each is set on a respective floor scale 28. In each MEA 16, the feed tube 24 is connected through the disc shaped platen 56 to communicate with the press cavity 60. The platen 56 is driven by hydraulic plunger 72. When a batch is set up by loading each chamber 50 of the feed system 12 battery, an operator can initiate a system cycle by controller 30 touch screen located at a work station. The controller 30 can be a microprocessor or computer or the like for controlling the MEA 16 as hereinafter described.

The operator can commence system operation at controller 30. When a cycle is activated by an operator, a plunger 72 of each container evacuator 22 of the battery shown in FIG. 1 is activated via control lines 74 (FIG. 4 and FIG. 5). Then, as the screw conveyor 18 starts turning, the press platen 56 with connected feed tube 24 is forced by hydraulically driven plunger 72 to travel down into the drum 42 interior. As further illustrated in FIG. 6, as platen 56 traverses the drum 42 longitudinal axis within the press cavity 60, drum contents are displaced upward into a connecting orifice 68 of the feed tube 24. As the platen 56 completes traversing the drum axis, all material is forced upward into the feed tube 24 to be eventually expelled from the feed tube discharge port 70.

The material is diced into small pieces by dicing apparatus 26 as it exits from the discharge port 70 to the conveyor 18 to charge to compounding system 14. Dicing can be accomplished by various cutting mechanisms, including a cutting head disposed at an outlet end of the feed tube. For example, Brandl, U.S. Pat. No. 5,797,516, incorporated hereto in its entirety discloses a cutting head formed by a knife that is detachably mounted in an axial direction and radial and tangential to the axial direction. The cutting head is rotatable relative to a feed tube about a common central longitudinal axis.

In the FIG. 4, FIG. 5 and FIG. 6 embodiment, the MEA 16 includes a dicing apparatus 26 located at discharge port 70. The dicing apparatus 26 includes rails 80 that secure cutting wire 82 to guide the wire 82 to cut material exiting the feed tube discharge port 70. The rails 80 secure the cutting wire 82 to traverse the feed tube 24 longitudinal axis at discharge port 70 when activated by controller 30 via lines 84 and 86.

The controller 30 of FIG. 1 illustrates an embodiment of the invention. Controller 30 is responsively connected to loss of weight scales 28 via lines 92 to sense loss of weight as material is expressed from the drums 42 to conveyor 18. The controller 30 computes a weight charged of material charged to the conveyor 18 by the difference between an initial weight of the MEA 16 and initially emplaced and full drum 42. In the embodiment of the drawings, the controller 30 can sense an initial total weight of all the MEAs 16 and emplaced full drums 42 of the MEA battery of for example, the three shown in FIG. 1. The controller 30 monitors the combined weight as material in the drums is evacuated to the conveyor 18. The controller 30 contemporaneously calculates a weight of material charged to the conveyor 18 and hence to the compounding system according to a difference between the initial total weight and contemporaneously sensed total weight.

The controller 30 also controls operation of dicing apparatus 26 according to the calculated charged material weight. Initially, the dicing apparatus 26 can be programmed to make cuts of about “football” sized material, for example to fit in a 14″ inner diameter screw conveyor 18. Once a piece of material is cut from the feed tube discharge port 70, floor scale 28 senses a contemporaneous weight and feeds this signal back to the controller 30. When the controller 30 senses a contemporaneous weight signal and calculates that a total charged weight is within a specified range of total material to be charged (for example within 15 pounds of “set point”) to the compounding system 14, the controller can signal the dicing apparatus 26 via lines 84 to increase cut frequently to produce smaller “diced” pieces. The smaller diced pieces at approach to set point permit improved control of feed to attain a charged material weight within a prescribed tolerance range, for example +/−2 pounds for a batch.

As the drum 42 evacuation process is completed, door clamps of the hinged closures 52 and 56 open and a controller 30 Run Screen displays “NEW DRUM.” A beacon light mounted on the container evacuator 22 turns yellow, indicating the drum 42 is ready to be changed. The chamber 50 hinged closures 52 and 56 open the hydraulic unit motor terminates. The door clamps are opened manually and the empty drum is removed, typically with the drum hauler. The press is reloaded with a drum the process repeated.

As material is charged from the presses to the screw conveyor, the conveyor is turning at low rpms to feed the material to the mixer. The screw is programmed to stop turning 90 seconds after the last press makes its last cut. We have determined this time to be adequate to clear all material from the conveyor.

Conveyor 18 transports and drops the silicone gum to chute 20, which drops the material into a material compounding system 14. In one silicone compounding process, a heat cured rubber (HCR) composition can be produced by kneading a high-viscosity polydiorganosiloxane, an inorganic filler and additives by means of a batch kneading machine such as the high intensity Banbury mixer 32 or a low intensity double arm dough mixer. In this process, silicone gum, inorganic filler, treating agents and additives are batch mixed until desired properties are obtained. In Kasahara et al., U.S. Pat. No. 5,198,171, a preconcentrate of silicone gum, inorganic filler and treating agents is formed by a high speed mechanical shearing mixer. The resulting premix is further compounded in a same-direction double screw extruder. A premix is formed in a first step wherein a silicone gum having a viscosity at 25° C. of 1×10⁵ cP or more, an inorganic filler and a treating agent are mixed in a high speed mechanical shearing machine to provide a flowable particulate mixture in which each ingredient is present in a substantially uniform, finely dispersed state. The flowable particulate mixture is then fed at a constant feed rate into a kneading and extruding machine that has two screws rotating in the same direction.

As the material exits from the end of the conveyor, it falls into a chute. It tumbles down the chute directly into the mixing chamber of a Banbury mixer where feed is mixed with filler and additives. In the FIGS. 1, 2 and 3 embodiment, the silicone gum drops through chute 20 to compounding system 14, which includes mixer 32 such as a Banbury, roll mill 34, conveyor belt 36 and compounder 38. The material dropped from chute 20 may be a feed of silicone gums of varying physical properties such as varying viscosity.

In the mixer 32 such as a Bepex Turbolizer, fumed silica, the silicone gum and a treating agent can be added to form a densified polymer/filler mass. After the gum feed is mixed it is dropped into the nip 46 of roll mill 34 where the material is rolled into a strip form. After a drop, the program logic controller (PLC) verifies that the mixer drop door has opened, then reclosed and is ready for feed. For any residual material that hangs in the chute, the “pusher” is programmed to sweep a few seconds after the conveyor stops. This serves to scrape down the chute, and ensure all material gets into the mixer to correctly formulate the batch.

The mill imparts a final mix to fully incorporate filler and to cool material. Then, the material is stripped from the mill a strip form. The strip form is fed by means of conveyor belt 36 into compounder 38, which may be an extruder. The compounder 38 serves to clean and form the material for packaging. The material can be packaged and boxed through an automated cut, weigh and packaging system.

The feed system and method of the invention can be used in conjunction with a process to compound a silicone rubber into a base for sealing compounds with additives such as pigments dosed to the rubber in appropriate quantities and mixed in large mixers or extruders. FIG. 11 illustrates an exemplary process wherein a filler such as fumed silica is continuously in situ treated and compounded with a silicone polymer such as a vinyl-terminated polydimethylsiloxane.

A heat cured rubber (HCR) comprises a high viscosity silicone polymer, an inorganic filler and various additives that aid processing or impart desired final properties to the composition. A vulcanizing agent or catalyst can be added and the composition heat cured to fabricate silicone rubber moldings such as gaskets, medical tubing and computer keypads. An HCR composition can be produced by kneading a high-viscosity polydiorganosiloxane, the inorganic filler and additives by means of a batch kneading machine such as a high intensity Banbury mixer or a low intensity double arm dough mixer. In this process, polydiorganosiloxane, inorganic filler, treating agents and additives are batch mixed until desired properties are obtained. In Kasahara et al., U.S. Pat. No. 5,198,171, a preconcentrate of polydiorganosiloxane, inorganic filler and treating agents is formed by a high speed mechanical shearing mixer. The resulting premix is further compounded in a same-direction double screw extruder. The premix is formed in a first step wherein a diorganopolysiloxane having a viscosity at 25° C. of 1×10⁵ cP or more, an inorganic filler and a treating agent are mixed in a high speed mechanical shearing machine to provide a flowable particulate mixture in which each ingredient is present in a substantially uniform, finely dispersed state. The flowable particulate mixture is then fed at a constant feed rate into a kneading and extruding machine that has two screws rotating in the same direction.

The following Example is illustrative and should not be construed as a limitation on the scope of the claims.

### EXAMPLE

This EXAMPLE is a combined description of press experiments at Schwerdtel US headquarters (New Jersey), ProSys Corporation (Missouri), and at GE Silicones Waterford, N.Y. Experiments on the shaftless screw conveyor were conducted at GE Silicones Waterford using Martin Sprocket equipment.

A viscous material feed system as schematically illustrated in the drawings included a Schwerdtel S 6-F drum press mounted to Vishay BLH floor scale that measured material flow according to loss of weight. The Schwerdtel S 6-F press included a hydraulic pressure driven cylinder and platen that drives a platen into a 55 gallon drum.

The feed system included a feed tube to receive material expressed from a drum by the press and a pneumatic solenoid operated cutting system that metered material from the feed tube to a 12″×24′ shaftless screw conveyor according to loss of weight sensed by the scale. The screw conveyor interfaced to a chute. The chute permitted material to fall via gravity directly to a Banbury mixer. Material remaining in the chute was cleared by a pneumatic pusher prior to each mix (GE design and fabrication). The system was controlled by operators at two (2) QuickPanel LM90 touch screens.

In operation, an operator first entered a set point into the system controller. The set point represented a target batch of silicone gum to be charged to a Banbury mixer, which was part of a silicone gum compounding system. A pallet of four (4) fifty-five (55) gallon drums of polymer (Viscosity Range 150,000 to 900,000 Poise) was placed on the drum carousel. The 55-gallon straight-sided steel drums were delivered by the carousel and one drum was loaded into the Schwerdtel S 6-F drum press using an Easy Lift Equipment Drum Hauler unit. The Schwerdtel S 6-F drum press was controlled by a GE Fanuc 90/30 PLC. Material was then displaced, from the drum to the feed tube by the hydraulic Schwerdtel gum press.

The operator pressed a START OR RESTRT BATCH button of the controller to commence operation. As the screw conveyor started turning, the hydraulically driven press platen commenced traveling down into the drum. As the platen traversed the drum, drum contents were squeezed upward into the feed tube. As the platen completed traversing the drum axis, all material was forced upward into the feed tube. As material exited the feed tube, a pneumatic solenoid operated cutting system diced the material into pieces that then fell into a 12″×24′ shaftless screw conveyor to charge to a Banbury mixer.

A batch of material flow from conveyor to the Banbury mixer was measured by loss of weight detected by the Vishay BLH load cells. A combined weight of presses, feed tubes, cutting mechanisms and material-containing drums was registered by the control system as a first weight. The control system monitored a charged weight of silicone gum to the Banbury by registering progressing weight as silicone gum was pressed from the drums and expelled through the feed tubes and cutting systems. The control system displayed a differential between the first weight and registered progressive weights that represented a charged silicone gum weight.

As the charged silicone gum weight was within 15 pounds of the set point, the pneumatic solenoid operated cutting system rate was increased to dice smaller aliquots of exiting material. A system operator observed the differential weight and terminated the batch operation when the differential weight registered within a ±2 pound range of the set point.

The EXAMPLE illustrates control of material charge to a compounding system according to a feed system of the invention.

The invention includes changes and alterations that fall within the purview of the following claims. The foregoing examples are merely illustrative of the invention, serving to illustrate only some of the features of the present invention. For example, the invention includes a controller with a set of instructions: to refer to a look-up data base to determine a set point for a material to be charged to a compounding system; sensing an initial combined weight of a material extracting apparatus and a container with material; signaling commencement of the material extracting apparatus operation to evacuate the material from the container; sensing a progressing combined weight of the material extracting apparatus and the container with material; calculating a charged material weight according to a difference between the initial combined weight and the sensed progressing combined weight; and terminating the material extracting apparatus operation when a calculated charged material weight is within a specified range of the set point.

The appended claims are intended to claim the invention as broadly as it has been conceived and the examples herein presented are illustrative of selected embodiments from a manifold of all possible embodiments. Accordingly it is Applicants' intention that the appended claims are not to be limited by the choice of examples utilized to illustrate features of the present invention.

As used in the claims, the word “comprises” and its grammatical variants logically also subtend and include phrases of varying and differing extent such as for example, but not limited thereto, “consisting essentially of” and “consisting of.”

Where necessary, ranges have been supplied, those ranges are inclusive of all sub-ranges there between. Such ranges may be viewed as a Markush group or groups consisting of differing pairwise numerical limitations which group or groups is or are fully defined by its lower and upper bounds, increasing in a regular fashion numerically from lower bounds to upper bounds. It is to be expected that variations in these ranges will suggest themselves to a practitioner having ordinary skill in the art and where not already dedicated to the public, those variations should where possible be construed to be covered by the appended claims.

It is also anticipated that advances in science and technology will make equivalents and substitutions possible that are not now contemplated by reason of the imprecision of language and these variations should also be construed where possible to be covered by the appended claims.

All United States patents (and patent applications) referenced herein are herewith and hereby specifically incorporated by reference in their entirety as though set forth in full.

The invention includes changes and alterations that fall within the purview of the following claims.

1. A viscous material feed system, comprising:
a container evacuator located on a loss of weight scale;
a feed tube that receives material expressed from a container by the container evacuator; and
a dicing apparatus that meters material from the feed tube to a processing system according to loss of weight sensed by the scale.

2. The viscous material feed system of claim 1, wherein the container evacuator comprises a chamber to hold the container and a plunger axially and slidably accommodated within the chamber.

3. The viscous material feed system of claim 1 wherein the container evacuator comprises a chamber to hold a material filled container and a plunger axially and slidably accommodated within the chamber to express material from the container into the feed tube that extends from the chamber with the dicing apparatus.

4. The viscous material feed system of claim 1, wherein the container evacuator comprises a drum press.

5. The viscous material feed system of claim 1, wherein the container evacuator comprises a chamber to hold the container and a plunger comprising a piston driven platen that is axially and slidably accommodated within the chamber.

6. The viscous material feed system of claim 1, for feed a viscous material,
wherein the container is filled with the viscous material, which is expressed by the container evacuator.

7. The viscous material feed system of claim 1, wherein the dicing apparatus is located at discharge port of the feed tube and comprises rails that slidably secure a cutting wire to guide the wire to cut material exiting the feed tube discharge port.

8. The viscous material feed system of claim 1, wherein the dicing apparatus is located at discharge port of the feed tube and comprises rails that slidably secure a cutting wire to traverse the feed tube longitudinal axis at discharge port to cut material exiting the feed tube discharge port.

9. The viscous material feed system of claim 1, further comprising a controller that activates a plunger axially and slidably within the container evacuator to express material from a container held within the container evacuator.

10. The viscous material feed system of claim 1, further comprising a controller with a set of instructions to (i) store an input value representing a material set point, (ii) sense an initial combined weight of the material extracting apparatus and a container with material; (iii) sense a progressing combined weight of the material extracting apparatus and the container with material as material is metered from the dicing apparatus; and (iv) calculate a material weight charged from the feed system to a subsequent process according to a difference between the initial combined weight and the sensed progressing combined weight.

11. The viscous material feed system of claim 1, further comprising a controller with a set of instructions to (i) store an input value representing a material set point, (ii) sense an initial combined weight of the material extracting apparatus and a container with material; (iii) sense a progressing combined weight of the material extracting apparatus and the container with material as material is metered from the dicing apparatus; (iv) calculate a material weight charged from the feed system to a subsequent process according to a difference between the initial combined weight and the sensed progressing combined weight; and terminate the material extracting apparatus operation when a calculated charged material weight is within a specified range of the set point.

12. The viscous material feed system of claim 1, further comprising a controller with a set of instructions to (i) store an input value representing a material set point, (ii) sense an initial combined weight of the material extracting apparatus and a container with material; (iii) sense a progressing combined weight of the material extracting apparatus and the container with material as material is metered from the dicing apparatus; (iv) calculate a material weight charged from the feed system to a subsequent process according to a difference between the initial combined weight and the sensed progressing combined weight; and (v) increasing the rate of metering of material by the dicing apparatus when the calculated material weight charged is within a predetermined range of the set point.

13. The viscous material feed system of claim 1, comprising a plurality of combinations of container evacuator, feed tube and dicing apparatus.

14. A viscous material feed method, comprising:
determining an initial weight of a combined feed system, container and viscous material held within the container;
evacuating viscous material from the container by the feed system for charge to a viscous material compounding process;
monitoring a weight of the combined feed system, container and viscous material, held within the container as material is evacuated;
determining an amount of viscous material charged to the compounding process according to a difference between the initial weight and a monitored weight of the combined feed system, container and viscous material held within the container as material is evacuated;
controlling a rate of dicing viscous material that is evacuated from the container for feed to the viscous material compounding process according to the determined amount of charged viscous material.

15. The viscous material feed method of claim 14, comprising dicing viscous material that is evacuated from the container for feed to the viscous material compounding process at a first rate and increasing the rate when the amount of viscous material charged to the compounding process attains a predetermined range of a set point of material.

16. The viscous material feed method of claim 14, comprising dicing viscous material that is evacuated from the container for feed to the viscous material compounding process at a first rate and increasing the rate when the amount of viscous material charged to the compounding process attains a 15 pound range of a set point of material.

17. The viscous material feed method of claim 14, comprising dicing viscous material that is evacuated from the container for feed to the viscous material compounding process at a first rate and increasing the rate when the amount of viscous material charged to the compounding process attains a predetermined range of a set point of material; and continuing dicing and charging material to the compounding process at a faster dicing rate to complete feed to the compounding process within a predetermined range of a set point of material.

18. The viscous material feed method of claim 14, composing dicing viscous material that is evacuated from the container for feed to the viscous material compounding process at a first rate and increasing the rate when the amount of viscous material charged to the compounding process attains a predetermined range of a set point of material; and continuing dicing and charging material to the compounding process at a faster dicing rate to complete feed to the compounding process within predetermined 2 pound range of a set point of material.

19. The viscous material feed method of claim 14, comprising evacuating viscous material from the container by driving a platen through a longitudinal axis of the container to express viscous feed material from the container.

20. The viscous maternal feed method of claim 14, comprising evacuating viscous material from the container by driving a platen through a longitudinal axis of the container to express viscous feed material from the container to a feed tube with a dicing apparatus to dice the viscous material to the compounding process.

22.-37. (canceled)

38. A method of controlling a feed to a processing system, comprising:
establishing a material feed session set point range;
feeding a viscous material in the session by dicing a steadily moving material into a portion that drops sequentially into the processing system;
monitoring a session total of material dropped into the processing system;
comparing the session total of material to the session set point range;
increasing a dicing rate of the moving material to decrease each diced portion quantity as the session set point range is approached; and
terminating the material feed of the session when the total material is within the session set point range.

39. A process of feed a material compounding system, comprising:
referring to a look-up data base to determine a set point for a material to be charged to the compounding system;
sensing an initial combined weight of a material extracting apparatus and a container with material;
signaling commencement of a material extracting apparatus operation to evacuate the material from the container;
sensing a progressing combined weight of the material extracting apparatus and the container with material:
calculating a charged material weight according to a difference between the initial combined weight and the sensed progressing combined weight; and
terminating the material extracting apparatus operation when a calculated charged material weight is within a specified range of the set point.
